(19) United States
(12) Patent Application Publication
(10) Pub. No.: US 2010/0061280 A1
(43) Pub. Date: Mar. 11, 2010

(54) Synchronizing signal extraction circuit for tdd system and method of the signal extraction

(76) Inventor: Chang Ho Lee, Gyeonggi-Do (KR)

Correspondence Address: GWIPS;Peter T. Kwon, Gwacheon P.O. Box 72, 119 Byeolyang Ro, Gwacheon City, Gyeonggi-Do, 427-600, KR

(21) Appl. No.: 12/310,823

(22) PCT Filed: Dec. 12, 2007
(86) PCT No.: PCT/KR2007/006458

§ 371 Date: Mar. 9, 2009

(30) Foreign Application Priority Data
Dec. 13, 2006 (KR) 1020060126799

(51) Int. Cl. H04J 3/00

(52) U.S. Cl. 370/280

(57) ABSTRACT

The present invention relates to a technology applied to mobile communication, and more particularly to a circuit of extracting a synchronizing signal from a received signal for retransmitting the received signal in synchronization with the synchronizing signal in a repeater of a TDD system, etc. The circuit generates the synchronizing signal in a phase locked to a phase of the received signal and outputs the synchronizing signal through a signal extractor. A synchronizing signal extraction circuit according to example embodiments of the present invention includes a band pass filter 10 for passing a signal having a desired frequency, a signal detector 20 for detecting a synchronizing signal from an output of the band pass filter 10, a digital filter 30 for filtering an output of the signal detector to remove a noise, a digitally-programmed phase-locked loop (DPPLL) 40 for restoring the synchronizing signal from an output of the digital filter to lock a phase of an output of an oscillator, the oscillator 50 for generating an electrical oscillation of clock or pulse type, and a signal extractor 60 for outputting the synchronizing signal using the output of the oscillator. The present invention has wide applicability since the synchronizing signal is extracted from a signal of TDD type, has a relatively simple configuration and high performance since the DPPLL is used, can be manufactured compactly at relatively low cost since the small number of components are included, and may reduce problems such as heat generation due to lowered power consumption according to reduction of the number of components.

### TECHNICAL FIELD

The present invention relates to mobile communication. More particularly, embodiments of the present invention relates to synchronizing signal extraction circuits and methods of extracting a synchronizing signal, which is synchronized with an input signal, in a repeater using protocols and/or specifications such as time division duplex (TDD).

### BACKGROUND ART

A synchronizing signal extraction circuit is used in a repeater of TDD systems adopting wireless broadband internet (WiBro), worldwide interoperability for microwave access (WiMAX), etc. The synchronizing signal extraction circuit extracts a synchronizing signal from a received signal for retransmitting the received signal in synchronization with the synchronizing signal.

In a conventional synchronizing signal extraction circuit as illustrated in FIG. 2, a radio frequency (RF) demodulator 70 converts a received RF signal to a signal of intermediate frequency, and it is digitalized by an analog-to-digital converter (DAC) 80. A code converter 90 interprets and converts codes of the digitalized signal and a synchronizing signal is obtained through a synchronizing signal detector 100. A signal extractor 110 generates a pulse having a pulsewidth of 5 ms and outputs the pulse for a TDD system. Alternatively, a synchronizing signal may be extracted using a match filter and a training symbol in orthogonal frequency division multiplexing (OFDM) symbols.

Such conventional synchronizing signal extraction circuits for TDD systems are limited in applicability since they may be used only to the OFDM systems or the mobile internet repeaters. Furthermore, the conventional synchronizing signal extr action circuits require the RF direct demodulator 70 and the ADC 80 for obtaining data and determines synchronizing timing points by extracting synchronizing data from the obtained data. Accordingly, the conventional synchronizing signal extraction circuits have disadvantages of degraded performance due to data loss by fading, complex configuration and high manufacturing cost according to the increased number of components. In addition, many components increase the amount of heat and power consumption, and thus a cooler may be required.

### DISCLOSURE OF INVENTION

### Technical Problem

As mentioned above, the conventional synchronizing signal extraction circuits have disadvantages such as narrow applicability, degradation of performance, and increase of occupation space, cost, heat and power consumption.

Accordingly a synchronizing signal extraction circuit having a relatively simple configuration, high performance, low cost, capable of solving the problems such as heat generation, is required.

Example embodiments of the present invention provide a synchronizing signal extraction circuit for solving the above problems.

### Technical Solution

A synchronizing signal extraction circuit according to example embodiments of the present invention, as illustrated in FIG. 1, includes a band pass filter 10 for filtering a received radio frequency (RF) signal to pass a signal within a predetermined frequency range, a signal detector 20 for detecting a synchronizing signal from an output of the band pass filter, a digital filter 30 for filtering an output of the signal detector to remove a noise, a digitally-programmed phase-locked loop (DPPLL) 40 for restoring the synchronizing signal from an output of the digital filter to lock a phase of an output of an oscillator, the oscillator 50 for generating an electrical oscillation of clock or pulse type having the phase that is locked in response to an output of the DPPLL, and a signal extractor 60 for extracting an output synchronizing signal of the oscillator.

The synchronizing signal extraction circuit according to example embodiments of the present invention, simply compared with the conventional circuits, extracts only on/off timing points of an input signal using the band pass filter 10 and the signal detector 20, and extracts the synchronizing signal using the on/off timing points. The signal passed through the signal detector 20 may include relatively large noise. Accordingly it passes through the digital filter 30 and the output of the digital filter 30 is filtered again by the DPPLL 40 and the oscillator 50. The signal extractor 60 performs delay compensation, if necessary, according to a delay of the input signal, and outputs the synchronizing signal.

### ADVANTAGEOUS EFFECTS

The conventional products, in advance, analyze data by direct demodulation, and generate a synchronizing signal only if particular data exist. In contrast, the synchronizing signal extraction circuit according to example embodiments of the present invention simply extracts only on/off timing points of an input signal using the signal detector 20, extracts the synchronizing signal using the digital filter 30, and then a noise or a phase noise according to multi-reflection delay as illustrated in FIGS. 7 and 8 is filtered again using the DPPLL 40, thereby enhancing characteristics against the phase noise. In this method, the stable output is possible such that the output can be maintained even though a signal is not input for some time duration. As such, the synchronizing signal extraction circuit according to example embodiments of the present invention has advantages of stable extraction of the synchronizing signal with simple configuration.

The present invention is not limited to a mobile internet repeater but may be applied to all kinds of apparatus that requires extracting a synchronizing signal from a TDD signal. Furthermore, the synchronizing signal extraction circuit according to example embodiments of the present invention can extract a synchronizing signal from an RF signal as well as an IF signal.

The synchronizing signal extraction circuit according to example embodiments of the present invention may be manufactured compactly in a relatively simple configuration at low cost, have high performance, and may solve the problems such as heat generation.

### BRIEF DESCRIPTION OF THE DRAWINGS

FIG. 1 is a block diagram illustrating a synchronizing signal extraction circuit according to an example embodiment of the present invention.

FIG. 2 is a block diagram illustrating a conventional synchronizing signal extraction circuit.

FIG. 3 is a timing diagram illustrating an output passed through the digital filter.

FIG. 4 illustrates a signal with noise passed through the signal detector.

FIG. 5 illustrates a signal filtered by the digital filter, which is input to the DPPLL.

FIG. 6 illustrates a signal input to the DPPLL from the oscillator.

FIGS. 7 and 8 illustrate signals including phase noise.

FIG. 9 is a flow diagram illustrating signal processing in the DPPLL.

FIG. 10 is a diagram illustrating a communication system for mobile internet to which the present invention is applied.

### REFERENCE NUMERALS OF IMPORTANT COMPONENTS

10: band pass filter 20: signal detector 30: digital filter
40: DPPLL 50: oscillator 60: signal extractor

### BEST MODE FOR CARRYING OUT THE INVENTION

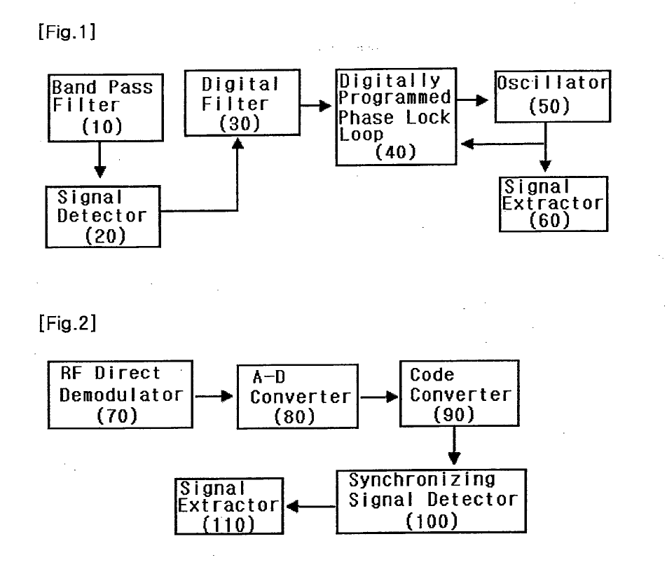

A synchronizing signal extraction circuit according to example embodiments of the present invention, as illustrated in FIG. 1, includes a band pass filter 10 for filtering a received radio frequency (RF) signal to pass a signal within a predetermined frequency range, a signal detector 20 for detecting a synchronizing signal from an output of the band pass filter, a digital filter 30 for filtering an output of the signal detector to remove a noise, a digitally-programmed phase-locked loop (DPPLL) 40 for restoring the synchronizing signal from an output of the digital filter to lock a phase of an output of an oscillator, the oscillator 50 for generating an electrical oscillation of clock or pulse type having the phase that is locked in response to an output of the DPPLL, and a signal extractor 60 for extracting an output synchronizing signal (typically referred to as s clock or a pulse) of the oscillator.

The band pass filter 10 performs a filtering function for passing only signals within a predetermined frequency range centered on a desired frequency. Typically the band pass filter 10 may be implemented with an analog filter.

The signal detector 20 is a device for discerning and detecting an original signal from a signal mixed with noise. The signal detector 20 may be implemented with a log detector, a root-mean-square (RMS) detector, a power detector, a peak detector, or an analog-digital converter, for detecting an input signal.

The digital filter 30 filters an output of the signal detector 20 to remove a noise included therein, and thus obtains the regular form characteristic of the signal.

The DPPLL 40 restores the synchronizing signal from an output of the digital filter using an ADC or a comparator, processes the restored synchronizing signal with a software program substituting components of a phase-locked loop (PLL), locks the phase of the electrical oscillation of the oscillator based on the output of the DPPLL 40, and transfers the output synchronizing signal to the signal extractor 60. The DPPLL 40 uses information stored in a memory device and is capable of controlling under complex and various conditions. Accordingly The DPPLL 40 can achieve ultra low frequency characteristic that is hard to be realized in convention electric components, and can filter noises such as an input phase jump noise that is not filtered by the digital filter 30.

The oscillator 50 generates the electrical oscillation of clock or pulse type and provides it to the DPPLL 40.

The signal extractor 60 outputs the synchronizing signal that is required in the system.

The synchronizing signal extraction circuit according to example embodiments of the present invention, simply compared with the conventional circuits, extracts only on/off timing points of an input signal using the band pass filter 10 and the signal detector 20, and extracts the synchronizing signal using the on/off timing points. The signal passed through the signal detector 20 may include relatively large noise. Accordingly it passes through the digital filter 30 and the output of the digital filter 30 is filtered again by the DPPLL 40 and the oscillator 50. The filtered signal is provided to the signal extractor 60 and the signal extractor 60 performs delay compensation, if necessary, according to a delay of the input signal, and outputs the synchronizing signal. Respective functions of the synchronizing signal extraction circuit according to example embodiments of the present invention are described as follows.

The band pass filter 10 may be implemented with an analog filter so as to pass only signals having a desired frequency.

The signal detector 20 is a device for discerning and detecting an original signal from a signal mixed with noise. The signal detector 20 may be implemented with a log detector, a root-mean-square (RMS) detector, a power detector, a peak detector, an analog-digital converter, and outputs the signal as illustrated in FIG. 4.

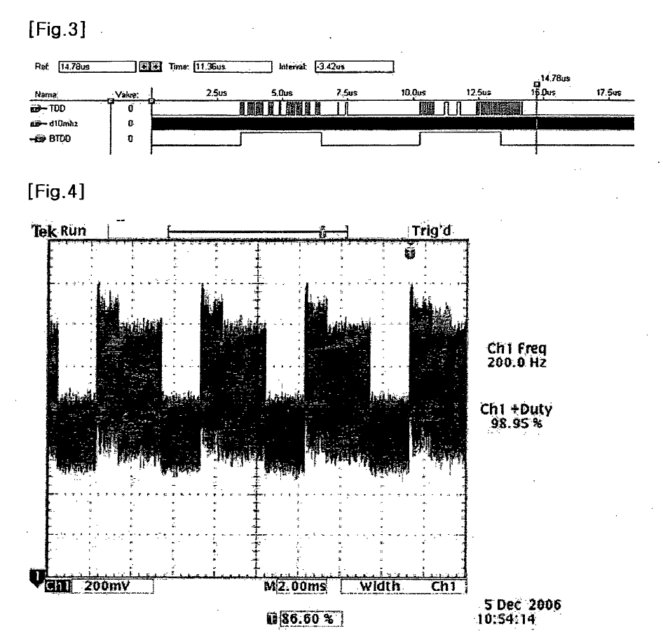

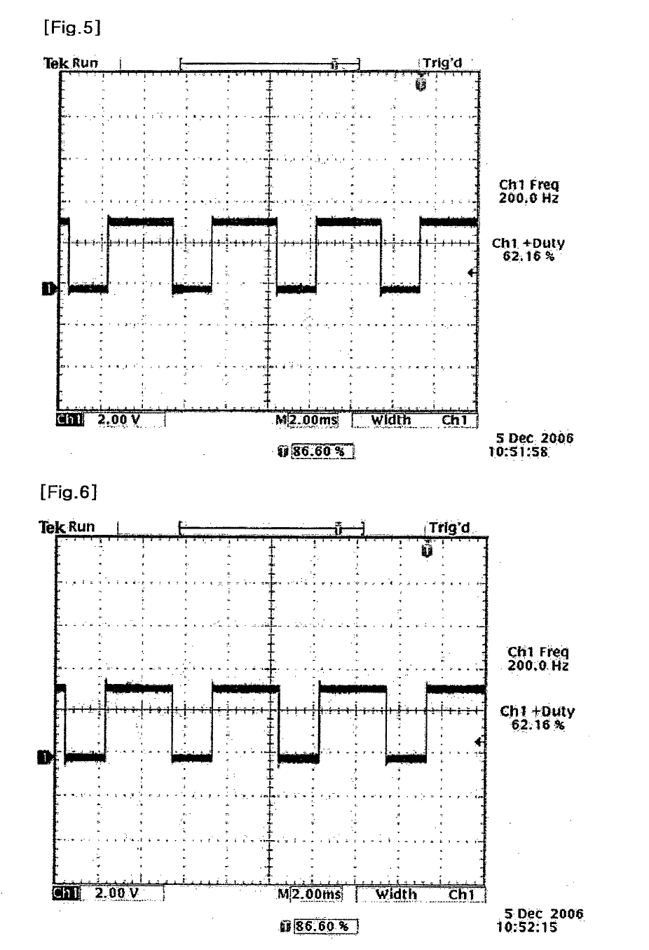

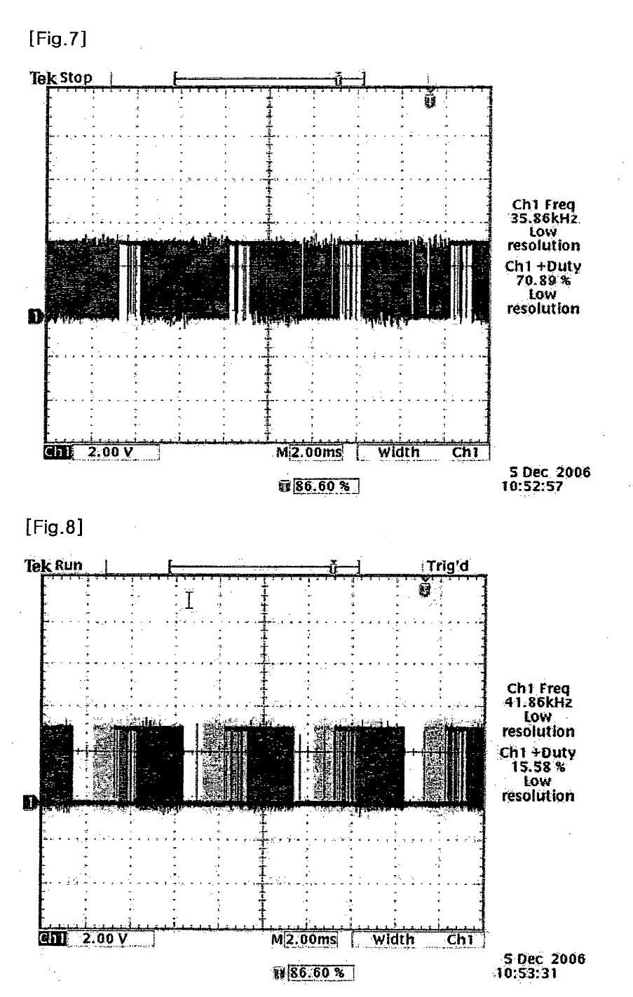

The output of the signal detector passes through the digital filter 30. The digital filter 30 filters the output of the signal detector 20 using a clock signal (digital 10 MHz) of a digital circuit to remove effects of the noise in the input signal TDD, and provides the output BTDD as illustrated in the timing diagram of FIG. 3. The digital filter 30 filters the output of the signal detector 20 as illustrated in FIG. 4 to output the signal as illustrated in FIG. 5. The digital filter 30 is characterized by the fact that it filters the input signal using the clock signal and a counter.

The output of the digital filter 30 as illustrated in FIG. 5 is input to the DPPLL 40. The DPPLL 40 compares the output of the digital filter 30 with the signal received from the oscillator 50 as illustrated in FIG. 6, and performs fine-tuning on the oscillator 50 to lock the input phase. The oscillator 50 may correspond to a temperature-compensated crystal oscillator (TCXO) or an ovenized voltage-controlled crystal oscillator (OCXO) that adjusts a voltage to control an output frequency. Here, the DPPLL 40 performs statistical process to obtain a standard deviation of the input phase variation using a software program. The conventional analog PLL is a closed-loop type that provides a fixed value using hardware, but the DPPLL adopted in example embodiments of the present invention is an open-loop type that uses statistical data processed by software.

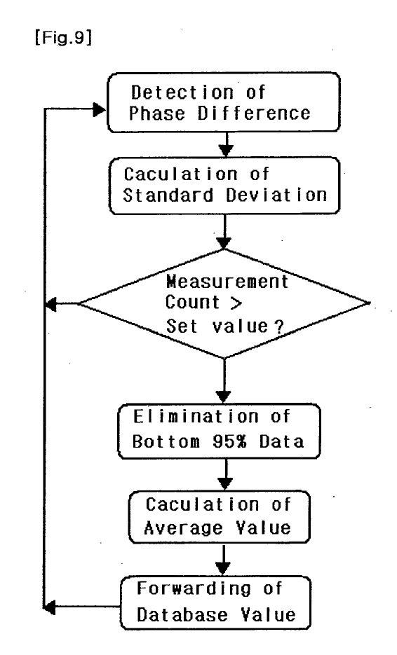

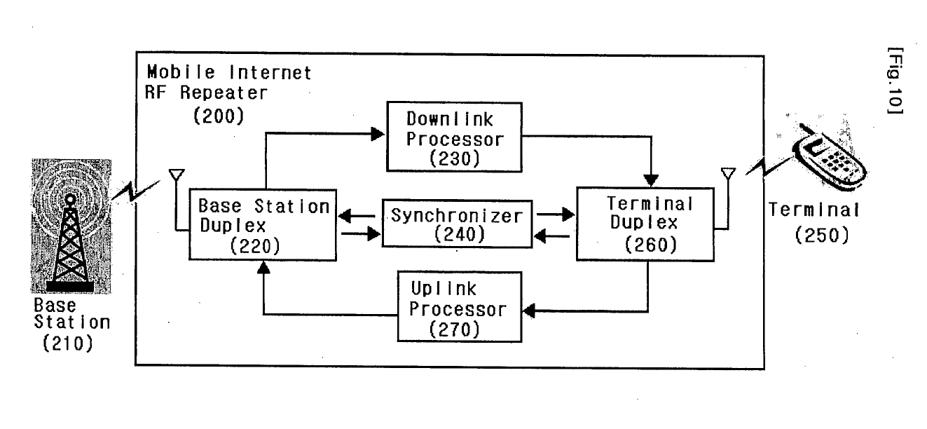

FIG. 9 is a flow chart illustrating processing algorithm of the software in the DPPLL 40. As illustrated in FIG. 9, Comparing the phases of the outputs of the oscillator 50 and the digital filter 30, the phase difference is detected. The standard deviation is calculated by accumulating the respective phase differences until the measurement count reaches a set value. When the measurement count exceeds the set value, the phase differences included in bottom 95% are eliminated, and an average value of the phase differences included in top 5% is calculated. The oscillator 50 has a configuration to be controlled based on such this average value. As such, the DPPLL 40 adopts an algorithm that increases the number of samples to use a convergence value corresponding to top 5% by eliminating the oscillation values corresponding to noise. Thus the measurement count can be varied according to input noise and/or stability of the oscillator 50, thereby capable of removing abnormal operation factors due to noise.

The signal extractor 60 generates the synchronizing signal based on the output of the oscillator 50, which is synchronized with the input signal by the DPPLL 40. The signal extractor 60 is characterized by outputting the synchronizing signal having a particular period.

Hereinafter, applicability and utility of the present invention will be described through one example of application.

In the recent wireless mobile communication, a duplex mode where channels are divided is used to prevent transmission interference between uplink communication to transfer information from a subscriber terminal to a base station and downlink communication to transfer information from the base station to the subscriber terminal. Among the duplex mode, frequency division duplexing (FDD) is used in CDMA, CDMA-1x, EV-DO, WCDMA, etc., and TDD is used in WiBro, TD-CDMA, TD SCDMA, etc. Considering the importance of securing channels, TDD has an advantage of performing bi-directional communication with a single frequency.

As one of domestic mobile internet standards of Korea, WiBro adopts the TDD protocol according to characteristic of 2.3 GHz frequency based on IEEE802.16e, and the OFDM protocol in which multiple users can communicate through the base station within a limited bandwidth suitable for a broadband mobile internet transmission, and WiBro leads the standard technology such as WiMAX, Mobile-WiMAX, etc.

The TDD type, using a single frequency based on time division on the uplink and downlink communications between the base station and the subscriber terminal, can provide equivalent services using a timeslot smaller than that of the FDD type. The TDD type adopts asymmetric time slots with respect to the uplink/downlink communications as the traffic of the Internet, and may provide services at relatively low cost since it can perform high-speed communication occupying half frequencies of the FDD type. The TDD, however, has a difficulty in synchronization detecting for dynamical assignment of timeslots, and has problems to be solved with respect to error rate, performance, and cost.

In systems adopting a TDD repeater for supplementing shading regions or enlarging cell coverage, cell radius may be limited or contracted due to limits of the TDD, communication disorders may occur by asynchronous operations between the system and the repeater due to propagation speed difference or handoff. Thus the entire TDD system needs to be synchronized to prevent such communication disorders. If the system is not synchronized, communication interruption becomes severe in case of terminal handover, and communication interruption occur in the boundary of cells since the Tx and Rx frames are crossed. Accordingly the maximum throughput can be achieved when the respective systems are exactly synchronized.

FIG. 10 illustrates an application example in which a synchronizing signal extraction circuit according to example embodiments of the present invention is applied to a mobile internet RF repeater in a WiBro system. Referring to FIG. 10, as an example of configurations of the RF repeater system to which the synchronizing signal extraction circuit according to example embodiments of the present invention may be applied, the mobile internet RF repeater 200 includes a downlink processor 230, a uplink processor 270 and a synchronizer 240 that provides downlink/uplink synchronizing signal to the downlink and uplink processors 230 and 270.

The downlink signal is processed by a base station duplex 220 that switches a receive mode and a transmit mode for wireless connection to the base station 210, and by the downlink processor 240 that amplifies, passes and converts the signal received from the base station 210. The uplink signal is processed by a terminal duplex 260 that switches a receive mode and a transmit mode for transfer the signal received from a terminal 250 to internal of the RF repeater 200, and by the uplink processor 240 that amplifies, passes and converts the signal received from the terminal 250. In this system, the synchronizer 240 corresponds to the synchronizing signal extraction circuit according to example embodiments of the present invention. The synchronizer 240 extracts the synchronizing signal from the uplink/downlink signals, and provides the output synchronizing signal to corresponding duplex, thereby synchronizing and repeating the transmit/receive signals.

### INDUSTRIAL APPLICABILITY

The synchronizing signal extraction circuit according to example embodiments of the present invention may be applied to a repeater in a TDD system such as a WiBro system, a WiMAX system, etc.

1. A synchronizing signal extraction circuit for a time division duplex (TDD) system, comprising:
a band pass filter 10 for filtering a received radio frequency (RF) signal to pass a signal within a predetermined frequency range;
a signal detector 20 for detecting a synchronizing signal from an output of the band pass filter;
a digital filter 30 for filtering an output of the signal detector to remove a noise;
a digitally programmed phase-locked loop (DPPLL) 40 for restoring the synchronizing signal from an output of the digital filter to lock a phase of an output of an oscillator;
the oscillator 50 for generating an electrical oscillation of clock or pulse type having the phase that is locked in response to an output of the DPPLL; and
a signal extractor 60 for extracting an output synchronizing signal of the oscillator.

2. The synchronizing signal extraction circuit of claim 1, wherein the signal detector 20 corresponds to one of a log detector, a root-mean-square (RMS) detector, a power detector, a peak detector, and an analog-digital converter.

3. The synchronizing signal extraction circuit of claim 1, wherein the digital filter 30 is configured to filter the output of the signal detector using a clock signal and a counter.

4. The synchronizing signal extraction circuit of claim 1, wherein the DPPLL 40 is configured to use statistical data processed by software.

5. The synchronizing signal extraction circuit of claim 1, wherein the oscillator 50 corresponds to a temperature-compensated crystal oscillator (TCXO) or an ovenized voltage-controlled crystal oscillator (OCXO) that adjusts a voltage to control an output frequency.

6. The synchronizing signal extraction circuit of claim 1, wherein the signal extractor is configured to output the output synchronizing signal having a particular period.

7. A method of generating a synchronizing signal for a time division duplex (TDD) system, comprising:
(i) filtering a received radio frequency (RF) signal to pass a signal within a predetermined frequency range;
(ii) detecting a synchronizing signal from the passed signal of step (i);
(iii) digitally-filtering the detected signal of step (ii) to remove a noise;
(iv) restoring the synchronizing signal from the digitally filtered signal of step (iii) to lock a phase of an oscillator;
(v) generating an output synchronizing signal of clock or pulse type having the locked phase of step (iv); and
(vi) extracting the output synchronizing signal generated in step (v).
